(19) United States
(12) Patent Application Publication
(10) Pub. No.: US 2022/0039627 A1
(43) Pub. Date: Feb. 10, 2022

(54) SANITIZING OR DISINFECTING MITT

(71) Applicants: Troy Vlahos, Philadelphia, PA (US); Christopher Smith, Wayne, PA (US)

(72) Inventors: Troy Vlahos, Philadelphia, PA (US); Christopher Smith, Wayne, PA (US)

(21) Appl. No.: 17/086,706

(22) Filed: Nov. 2, 2020

Related U.S. Application Data
(60) Provisional application No. 63/061,408, filed on Aug. 5, 2020.

(51) Int. Cl. A47L 13/19

(52) U.S. Cl. CPC A47L 13/19

(57) ABSTRACT

A sanitizing mitt includes an impervious inner layer provided with a permeable outer layer provided with a sanitizing material.

### CROSS-REFERENCE TO RELATED APPLICATION

This application claims the priority of U.S. Provisional Patent Application No. 63/061,408, filed Aug. 5, 2020, which is incorporated by reference in its entirety herein.

### BACKGROUND OF THE INVENTION

### 1. Field of the Invention

The present invention relates generally to the field of cleaning and sanitizing.

### 2. Brief Description of the Prior Art

Cleaning has been an important human activity from time immemorial. Once the germ theory of disease was empirically confirmed, cleaning to avoid disease causing agents became important. Since the onset of the COVID 19 pandemic, cleaning and sanitizing surfaces has become universal, particularly for businesses with direct contact with live customers, where surfaces are typically cleaned and sanitized after each use. While conventional cleaning supplies will provide the desired result, the number of repeated cleanings required can pose a substantial challenge. Cleaning agents active enough to sanitize may pose a risk of damage to the skin of the user. There is a continuing need for cleaning supplies which are readily accessible, easy to use, and which also may be disposed of after a single use.

### SUMMARY OF THE INVENTION

The present invention provides a sanitizing or disinfecting mitt comprising an inner layer adapted to conform to the human hand. The inner layer is preferably formed from an impervious synthetic plastic material, such as polypropylene, and includes an upper sheet having a peripheral edge and a lower sheet having a peripheral edge. Preferably, the peripheral edge of the upper sheet and the peripheral edge of the lower sheet are joined together along a first edge section and not joined along a second edge section. The sanitizing mitt also preferably includes a permeable outer layer adapted to conform to the human hand. Preferably, the outer layer includes an upper sheet having a peripheral edge and a lower sheet having a peripheral edge. Preferably, the peripheral edge of the upper sheet and the peripheral edge of the lower sheet are joined along a first edge section and not joined along a second edge section. Further, the sanitizing mitt also preferably includes a fluid sanitizing composition disposed in the permeable outer layer.

In one aspect, the upper sheet of the inner layer and the upper sheet of the outer layer of the sanitizing mitt are joined along the second edge section of the upper sheet of the inner layer and the second edge section of the outer layer, and the lower sheet of the inner layer and the lower sheet of the outer layer of the sanitizing mitt are joined along the second edge section of the inner layer and the second edge section of the outer layer.

In another aspect, the outer layer is formed from a nonwoven material.

Preferably, the sanitizing composition is selected a composition approved by a governmental authority for use against COVID-19. Preferably, the sanitizing composition is selected from List N, COVID 19 Disinfectants, of the Environmental Protection Agency.

Preferably, the sanitizing composition includes an active ingredient effective against COV-19. Preferably, the concentration of active ingredient in the sanitizing composition is effective to inactivate COVID-19.

In another aspect, the inner layer and the outer layer have a three-fingered conformation, and are joined to provide a three-fingered mitt or glove.

### BRIEF DESCRIPTION OF THE DRAWINGS

FIG. 1 Is an exploded schematic perspective view of a first embodiment of a sanitizing mitt according to the present invention.

FIG. 2 is a schematic bottom view of the sanitizing mitt of FIG. 1 shown in an open configuration for receiving the hand of a user.

FIG. 3 is a top plan view of a second embodiment of a sanitizing mitt according to the present invention.

### DETAILED DESCRIPTION

The present invention provides a disposable sanitizing or disinfecting mitt which can be used to quickly clean and sanitize a variety of surfaces while protecting the hand of the individual using the mitt from both the sanitizing composition employed and from contact with the contaminated surfaces being cleaned. The mitt includes at least two layers, an inner layer formed from an impervious synthetic plastic material such as polyethylene, and an outer layer in which the sanitizing composition is disposed.

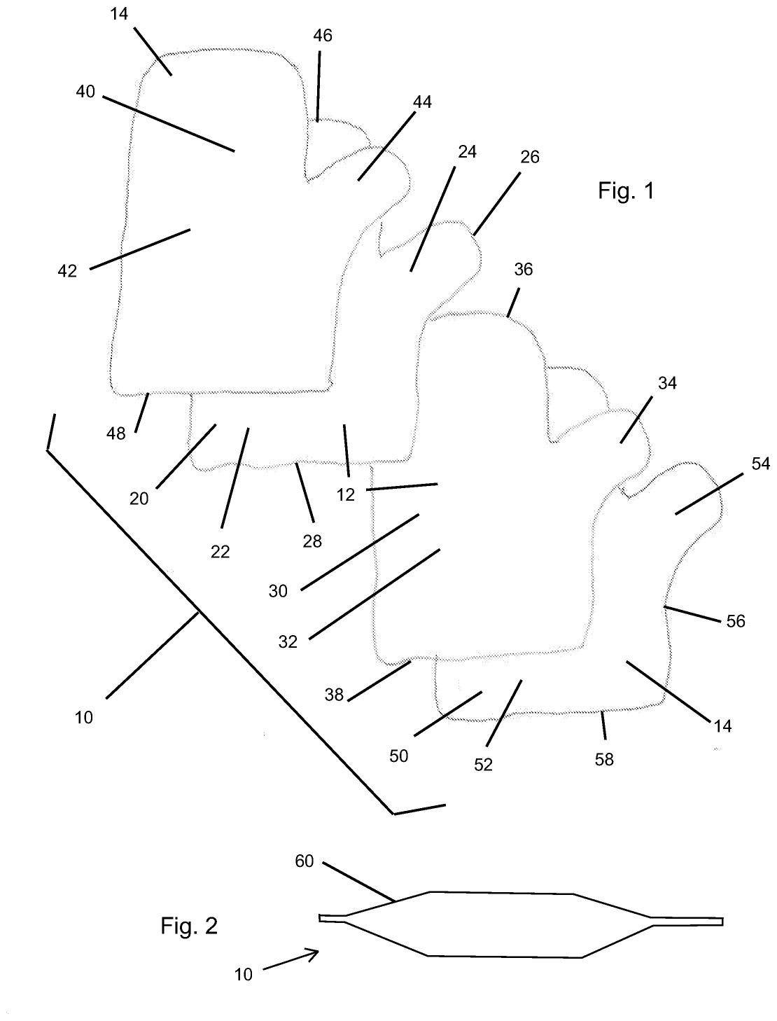

Referring now to the figures in which like reference numerals represent like elements in each of the several views, there is shown in FIG. 1 an exploded perspective view of the sanitizing mitt 10 according to the present invention. The sanitizing mitt 10 includes an inner layer 12 and an outer layer 14, preferably the outer layer 14 is bonded to the inner layer 12, such as with an adhesive material. In another aspect of the present invention, the outer layer 14 is coated onto the inner layer 12. The inner layer 12 is shaped and adapted to conform to the human hand.

In one presently preferred embodiment, the inner layer 12 is shaped like a conventional oven mitt or the like, with a main body portion for enclosing most of the hand of a user, other than the thumb, and a thumb portion for enclosing the user's thumb. Preferably, the inner layer 12 is formed from an impervious, flexible synthetic plastic material, such as polypropylene, which protects the hand of the user enclosed by the inner layer 12 from contact with either the surfaces being sanitized or the sanitizing composition,

In one presently preferred embodiment, the inner layer 12 includes an upper sheet 20 having a peripheral edge 25 and a lower sheet 30 having a peripheral edge 35. The peripheral edge 25 of the upper sheet 20 and the peripheral edge 35 of the lower sheet 30 are joined together along respective first or body edge sections 26, 36 and not joined along respective second or cuff edge sections 28, 38.

In one aspect of the present invention, the upper sheet 20 and lower sheet 30 are cut from a sheet of film stock material and adhered together along the respective body edge sections 26, 36, such as with an adhesive material, or in the alternative, thermally bonded such as by use of an ultrasonic device. In another aspect both the upper sheet 20 and the lower sheet 30 are formed as a single, integral unit from a thermoplastic material by a process such as blow molding or the like. The material from which the inner layer 12 is formed is preferably sufficiently flexible such that the user can easily grasp objects with the gloved hand.

The sanitizing mitt 10 also includes a permeable outer layer 14 likewise shaped and adapted to conform to the human hand and formed from an upper sheet 40 and a lower sheet 50. The outer layer 14 includes an upper sheet 40 having a peripheral edge 45 and a lower sheet 50 having a peripheral edge 55. The peripheral edge 45 of the upper sheet 40 and the peripheral edge 55 of the lower sheet 50 are joined together along respective third or body edge sections 46, 56 and not joined along respective fourth or cuff edge sections 48, 58.

In one aspect of the present invention, the upper sheet 40 and lower sheet 50 are cut from a sheet of stock material and adhered together along the respective body edge sections 46, 56, such as with an adhesive material, or in the alternative, thermally bonded such as by use of an ultrasonic device.

In another aspect, both the upper sheet 40 and the lower sheet 50 are formed as a single, integral unit from a stock material. In yet another aspect, the outer layer 14 is formed in situ on the exterior surface of the inner layer 12 such as by coating the inner layer 12 with a fluid composition and subsequently curing the fluid composition such as by drying the fluid composition or chemically crosslinking the fluid composition to form the outer layer 14.

In one aspect of the present invention, the upper sheet 40 of the outer layer 14, the upper sheet 20 of the inner layer 12, the lower sheet 30 of the inner layer 12, and the lower sheet 50 of the outer layer 14 are superposed, as represented in FIG. 1, and the body edge sections 46, 26, 36, 56 are simultaneously bonded together such as by use of an ultrasonic device.

In one presently preferred embodiment, the outer layer 14 comprises a nonwoven material permeably to a sanitizing composition. The nonwoven material can be formed from natural fibers such as cotton or synthetic fibers such as fibers of a synthetic thermoplastic or thermosetting material. The fibers may be mechanically processed and/or chemically treated to optimize retention by and release from the nonwoven material of a selected sanitizing composition.

The sanitizing mitt 10 also includes a sanitizing composition disposed in the permeable outer layer 14 of the mitt 10. The sanitizing composition is preferably a fluid or semi-fluid material effective at killing pathological organisms such as harmful bacteria and viruses. In one aspect of the present invention, the sanitizing composition includes ethanol. The sanitizing mitt 10 is preferably packaged such that the sanitizing composition is retained in the outer layer 14 of the mitt 10 until the packaging is opened by the user. When the packaging is opened, the sanitizing composition, which preferably wets the exterior surface of the outer layer 14, can be applied to the surface being sanitized by contacting that surface with the outer layer 14 of the mitt 10.

Preferably, the sanitizing composition is selected a composition approved by a governmental authority for use against COVID-19. Preferably, the sanitizing composition is selected from List N, COVID 19 Disinfectants, of the United States Environmental Protection Agency. Preferably, the sanitizing composition includes at least one active ingredient and optional addition ingredients such as one or more diluents, stabilizers, preservatives, and the like. Preferably, the at least one active ingredient is selected from the group comprising 1-2-hexandiol, chlorine dioxide, citric acid, I-lactic acid, dodecylbenzenesulfonic acid, glycolic acid, hydrochloric acid, quaternary ammonium compounds, hydrogen peroxide, peroxyacetic acid, peroxyoctanoic acid, silver, iodine, hypochlorous acid, phenolic compounds, tetraacetyl ethylenediamine isopropynol, ethanol, sodium hypochlorite, octanoic acid. sodium dichloroisocyanurate, sodium dichloroisocyanurate dihyrdrate, potassium peroxymonosulfate, glutaraldehyde, sodium carbonate peroxyhydrate, sodium chlorite, and thymol.

In one presently preferred embodiment of the sanitizing mitt 10 according to the present invention, the upper sheet 20 of the inner layer 12 and the upper sheet 40 of the outer layer 14 are joined along the second or cuff edge section 28 of upper sheet 20 of the inner layer 12 and the second or cuff edge section 48 of the outer layer 14, and the lower sheet 30 of the inner layer 12 and the lower sheet 50 of the outer layer 14 are joined along the second or cuff edge section 38 of the lower sheet 30 of the inner layer 12 and the second or cuff edge section 58 of the lower sheet 50 of the outer layer 14, thus permitting a user to insert a hand between the upper sheets 20, 40 and lower sheets 30, 50.

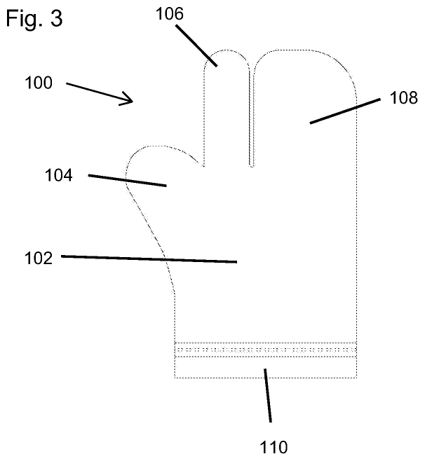

In another embodiment, the present invention provides a three-fingered glove or mitt 100, such as illustrated in FIG. 3. The three-fingered mitt 100 includes a body 102 having a cuff portion 110 at one end permitting the hand of a user to be inserted, an upward extending first compartment 104 for receiving the thumb of a user, an adjacent upward extending second compartment 106 for receiving the forefinger of a user, and an adjacent upward extending third compartment 108 for receiving the remaining three fingers of a user.

In other embodiments, the mitt of the present invention can take the shape of a five fingered glove, an oval, a circle, a square, or the like.

While the outer layer 14 may be coextensive with, and cover the entire outer surface of the inner layer 12, in other embodiments, the outer layer 14 covers only portions of the outer surface of the inner layer 12 (not shown), such as the fingers and the palm portions of the mitt 10, or the entire surface other than the portion covering the back of the user's hand.

Various modifications can be made in the details of the various embodiments of the apparatus of the present invention, all within the scope and spirit of the invention as defined by the appended claims.

1. A sanitizing or disinfecting mitt,
the mitt including a thumb portion for enclosing the user's thumb and a main body portion for enclosing most of the user's hand other than the thumb, the thumb portion including a thumb cavity, the mitt providing full hand coverage including the carpal area and the wrist area of the hand to provide protection against germs and bacteria, and further comprising:
an inner layer adapted to conform to the human hand, the inner layer formed from an impervious synthetic plastic material, the inner layer including an upper sheet having a peripheral edge and a lower sheet having a peripheral edge, the peripheral edge of the upper sheet and the peripheral edge of the lower sheet being joined together along a first edge section and not joined along a second edge section;
a permeable outer layer adapted to conform to the human hand, the outer layer including an upper sheet having a peripheral edge and a lower sheet having a peripheral edge, the peripheral edge of the upper sheet and the peripheral edge of the lower sheet along a first edge section and not joined along a second edge section; and
a fluid sanitizing composition disposed in the permeable outer layer.

2. The sanitizing mitt according to claim 1 wherein the upper sheet of the inner layer and the upper sheet of the outer layer are joined along the second edge section of the upper sheet of the inner layer and the second edge section of the outer layer, and the lower sheet of the inner layer and the lower sheet of the outer layer are joined along the second edge section of the inner layer and the second edge section of the outer layer.

3. The sanitizing mitt according to claim 1 wherein the outer layer is formed from a nonwoven material.

4. The sanitizing mitt according to claim 1 wherein the inner layer is formed from polypropylene.

5. The sanitizing mitt according to claim 1 wherein the sanitizing composition includes an active ingredient effective against SARS-CoV-2.

6. The sanitizing mitt according to claim 5 wherein the concentration of the active ingredient in the sanitizing composition is effective to kill or inactivate SARS-CoV-2 COVID-19.

7. The sanitizing mitt according to claim 1, the inner layer and outer layer having a three-fingered configuration.
